(19) United States
(12) Patent Application Publication
(10) Pub. No.: US 2012/0144303 A1
(43) Pub. Date: Jun. 7, 2012

(54) HD WEBSITE SKIN

(76) Inventors: Michael Cricks, Los Angeles, CA (US); Walter Geer, Bronx, NY (US)

(21) Appl. No.: 13/269,808

(22) Filed: Oct. 10, 2011

Related U.S. Application Data
(60) Provisional application No. 61/391,561, filed on Oct. 8, 2010.

(51) Int. Cl. G06F 3/00; G06F 15/16; G09G 5/00

(52) U.S. Cl. 715/719; 345/629; 709/219

(57) ABSTRACT

A high definition website skin is provided, including a file containing computer executable instructions is executed on a host processor of a computer apparatus, directing the apparatus to render a webpage, the file including a high-definition video background rendering portion and a content overlay rendering portion.

### CROSS REFERENCE TO RELATED APPLICATIONS

The present application claims priority to U.S. Provisional Patent Application Ser. No. 61/391,561, filed Oct. 8, 2010, the entire contents of which are specifically incorporated by reference herein.

### TECHNICAL FIELD

This invention relates generally to media displayed on websites. More particularly, this invention relates to methods, interfaces, and systems for providing rich media to users through a website.

### BACKGROUND OF THE INVENTION

Conventionally, websites present media and other content to a user through the use of links or embedded files. These files are stored at a server and retrieved upon access of the website at a client terminal or web browser. It follows that as a user proceeds to interact with the website, multiple files are accessed at different times through different embedded links on the website, some files may be unavailable, and the user experience may be unsatisfactory due to the aggregated nature of a typical “click through link” website. For example, if a website presents a user with video content, the content is displayed through an embedded video player application. The embedded video player application includes user controls such as play, fast-forward, et cetera, and is visually distinct from the remaining content on the web page. Furthermore, should a user wish to increase the size of the video player to better view the video being played back, there is typically only the option of activating a “full screen” mode which entirely obscures other content on the webpage which may be useful in enjoying the video content.

Accordingly, there is a need in the art for an improved system and method for providing rich media to users through a website.

### SUMMARY

The above described and other problems and disadvantages of the prior art are overcome and alleviated by the present high definition website skin. In exemplary embodiments, a file containing computer executable instructions is executed on a host processor of a computer apparatus, directing the apparatus to render a webpage, the file including a high-definition video background rendering portion and a content overlay rendering portion.

Exemplary embodiments also provide a method of providing rich media content to users, including creating a webpage, the webpage including a high-definition video background and overlaying content; serving the webpage to a client; monitoring client interaction with the served webpage; and rearranging the webpage overlaying content in response to monitored user interaction, the rearranging including increasing or decreasing an amount of video presented to a user as viewed through exposed portions of the high-definition video background, the increasing and decreasing facilitated through increasing or decreasing the sizes exposed portions of the high-definition video background.

Other exemplary embodiments provide a system of providing rich media content to users, including: a website server; and a third party webpage rendering server in communication with the website server, the third party webpage rendering server is configured to perform a method, comprising: creating a webpage, the webpage including a high-definition video background and overlaying content; serving the webpage to a client; monitoring client interaction with the served webpage; rearranging the webpage overlaying content in response to monitored user interaction, the rearranging including increasing or decreasing an amount of video presented to a user as viewed through exposed portions of the high-definition video background, the increasing and decreasing facilitated through increasing or decreasing the sizes exposed portions of the high-definition video background.

Other exemplary embodiments provide a system of providing rich media content to users, including: an advertising server; a website server in communication with the advertising server; and a third party webpage rendering server in communication with the advertising server and the website server, the third party webpage rendering server is configured to perform a method, comprising: receiving high-definition video background content from the advertising server; receiving overlaying content from the website server; creating a webpage, the webpage including the high-definition video background and overlaying content; serving the webpage to a client; monitoring client interaction with the served webpage; rearranging the webpage overlaying content in response to monitored user interaction, the rearranging including increasing or decreasing an amount of video presented to a user as viewed through exposed portions of the high-definition video background, the increasing and decreasing facilitated through increasing or decreasing the sizes exposed portions of the high-definition video background.

Other exemplary embodiments provide a system of providing rich media content to users, including: a plurality of clients; and a webpage rendering server in communication with the plurality of clients, the webpage rendering server configured to create and store a file, the file including computer executable instructions that when executed on a host processor of a computer apparatus, direct the apparatus to render a webpage, the file comprising: a high-definition video background rendering portion; and a content overlay rendering portion.

The above discussed and other features and advantages of the present invention will be appreciated and understood by those skilled in the art from the following detailed description and drawings.

### BRIEF DESCRIPTION OF THE DRAWINGS

Referring to the exemplary drawings wherein like elements are numbered alike in the several FIGS.:

FIG. 1 illustrates a user interface or webpage schematic, according to an example embodiment;

FIG. 2 illustrates a user interface or webpage schematic, according to an example embodiment;

FIG. 3 illustrates a user interface or webpage diagram, according to an example embodiment;

FIG. 4 illustrates a user interface or webpage diagram, according to an example embodiment;

FIG. 5 illustrates a user interface or webpage diagram, according to an example embodiment;

FIG. 6 illustrates a user interface or webpage diagram, according to an example embodiment;

FIG. 7 illustrates a user interface or webpage diagram, according to an example embodiment;

FIG. 8 illustrates a flowchart of a method, according to an example embodiment;

FIG. 9 illustrates a system and network, according to an example embodiment;

FIG. 10 illustrates a computer apparatus, according to an example embodiment;

FIG. 11 illustrates a computer program product, according to an example embodiment; and

FIGS. 12-23 illustrate a webpage interface operating according to the method of FIG. 8, and provided/served through a system at least somewhat similar to the system/network depicted in FIG. 9.

### DETAILED DESCRIPTION

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be further understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will also be understood that the terms “photo,” “photograph,” “image,” or any variation thereof may be interchangeable. Thus, any form of graphical image may be applicable to example embodiments.

It will also be understood that the terms “audio,” “audio tracks,” “music,” “music tracks,” or any variation thereof may be interchangeable. Thus any form of audio may be applicable to example embodiments.

It will also be understood that the terms “media,” “multi-media,” “video,” “HD video,” “HD video content,” or any variation thereof may be interchangeable. Thus any form of rich media may be applicable to example embodiments.

It will also be understood that the terms “frame,” “overlay,” “template,” or other similar terms may be used to refer to a portion of a website structured such that content may be arranged in a particular manner, but should not exclude other interpretations based upon a particular context in which the term is being used.

Similarly, the terms “background,” “webpage background,” “skin,” “webpage skin,” and other similar terms may be used to refer to a portion of a webpage where all content is arranged thereon.

Furthermore, it should be understood that any description of portions of a webpage herein should not be construed as separate and distinct files/elements based upon these portions, but rather fluidly integrated dynamic content partitions within a single or relatively small number of files which constitute the webpage. For example, a webpage or website herein may be described as having a “Background,” and “dynamic frame,” but these two elements may actually be contained in a single file or a minimal number of files, rather than a typically larger number of files distributed across a storage system.

It should also be understood that other terms used herein may be applicable based upon any associated definition as understood by one of ordinary skill in the art, although other meanings may be applicable depending upon the particular context in which terms are used.

Therefore, the terminology used herein is for the purpose of describing particular embodiments only and is not intended to be limiting of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Further to the brief description provided above and associated textual detail of each of the figures, the following description provides additional details of example embodiments of the present invention.

As described herein, example embodiments of the present invention may include methods and systems of providing rich media to users through a website.

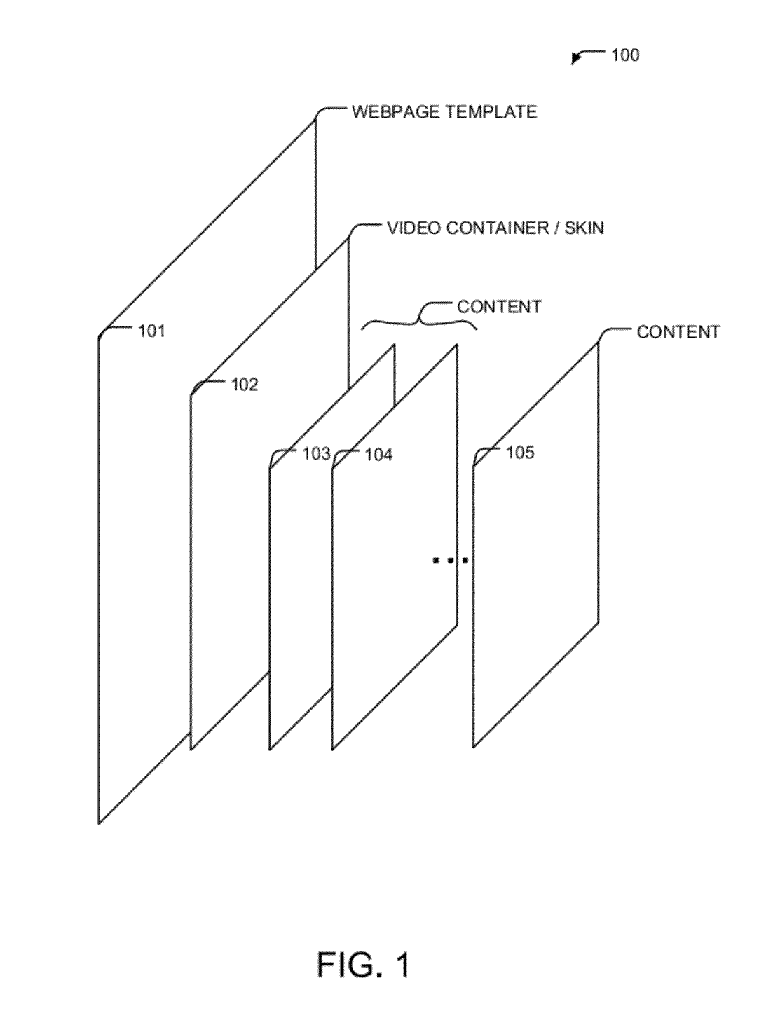

FIG. 1 illustrates a user interface or webpage schematic 100, according to an example embodiment. As illustrated, the webpage 100 includes a webpage template 101 and video container or skin 102. The webpage template 101 and skin 102 may be a single element, or may be separated as illustrated. The webpage 100 may also contain a plurality of content 103-105 disposed on, or alternatively arranged within, the video container/skin 102. The webpage template 101, skin 102, and content 103-105 may be rendered/ingested and stored in a single file, for example, a FLASH file, .SWF file, or other suitable file which may be configured to include a plurality of content 103-105 within or arranged on video container 102 comprising an entire background portion of the webpage template 101.

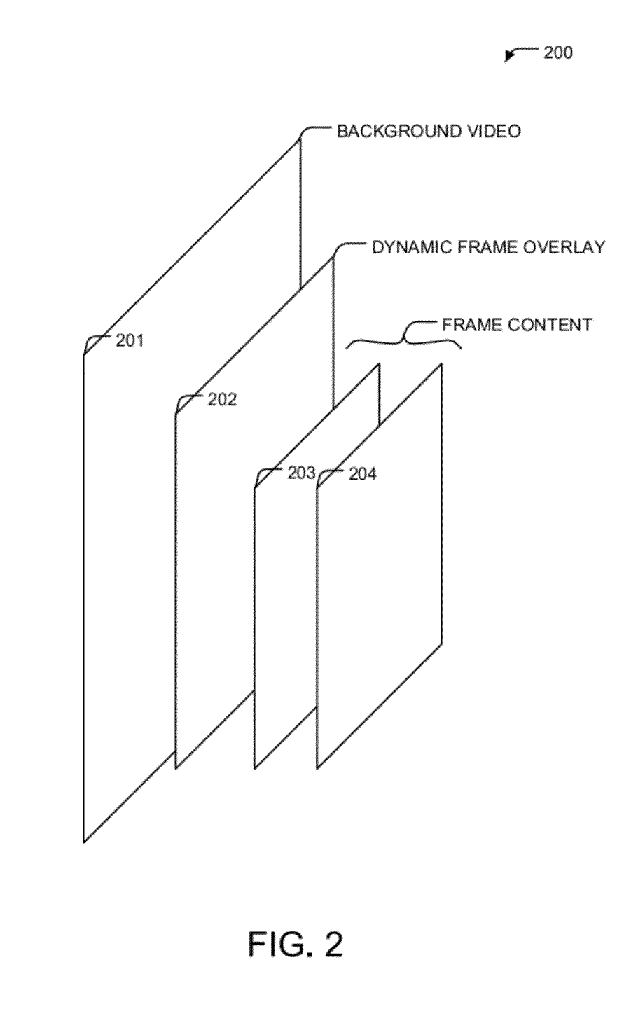

FIG. 2 illustrates a user interface or webpage schematic, according to an example embodiment. As shown, a background video or video skin 201 is positioned beneath a dynamic frame overlay 202, which includes a plurality of frame content 203-204 thereon. The background video 201 may cover an entire background of the webpage 200. For example, the background video 201 may be somewhat similar to a combination of elements 101-102 of FIG. 1. Furthermore, the background video 201, dynamic frame 202, and frame content 203-204 may all be rendered/ingested and stored in a single file, for example, a FLASH file, .SWF file, or other suitable file which may be configured to include the plurality of frame content 203-204 and at least the dynamic frame overlay 202 with the background video skin 201 rendered from video content. Although FIGS. 1-2 have been illustrated as including a plurality of content and a plurality of frame content separately, it should be understood that any combination of content including headers, header content, media, images, audio, more than one dynamic frame, or any other suitable content may be likewise included in any desired implementation without departing from the spirit and scope of example embodiments.

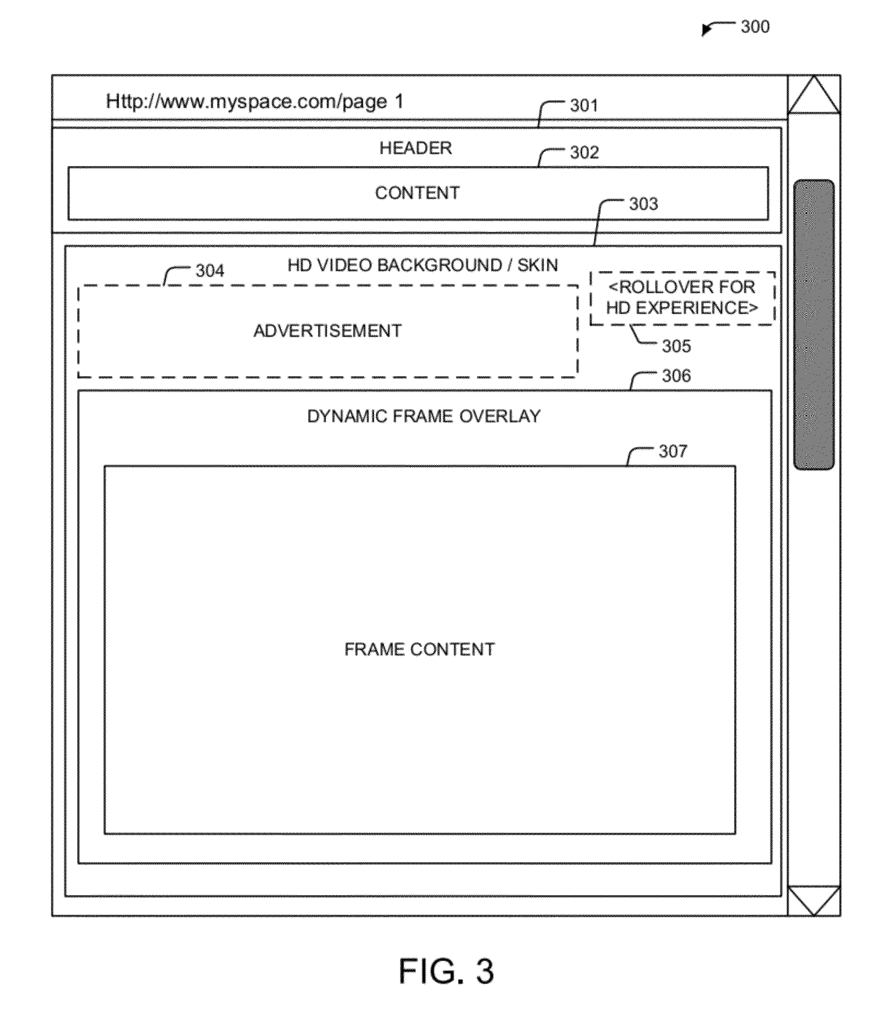

FIG. 3 illustrates a user interface or webpage diagram 300, according to an example embodiment. As illustrated, a video background/skin 303 is positioned behind/beneath all webpage content. The video skin 303 may be activated or changed through user interactions, for example, by clicking or by positioning a cursor over exposed HD content (e.g., portion 305) on the video skin 303. The webpage 300 further includes a dynamic frame overlay 306 with frame content 307, a header 301 with header content 302, and other features. All of the above-described content may be positioned upon, or alternatively within, the video skin 303. The webpage 300 may be contained within a single file as described above with regards to FIGS. 1-2.

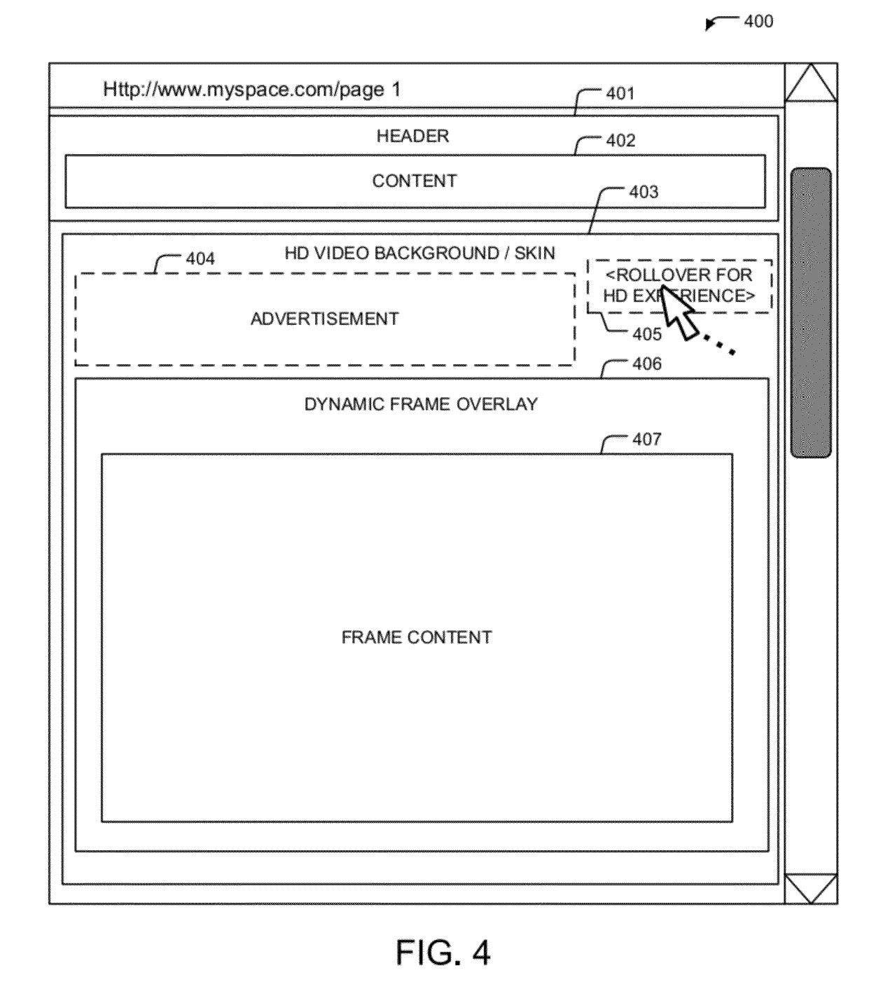

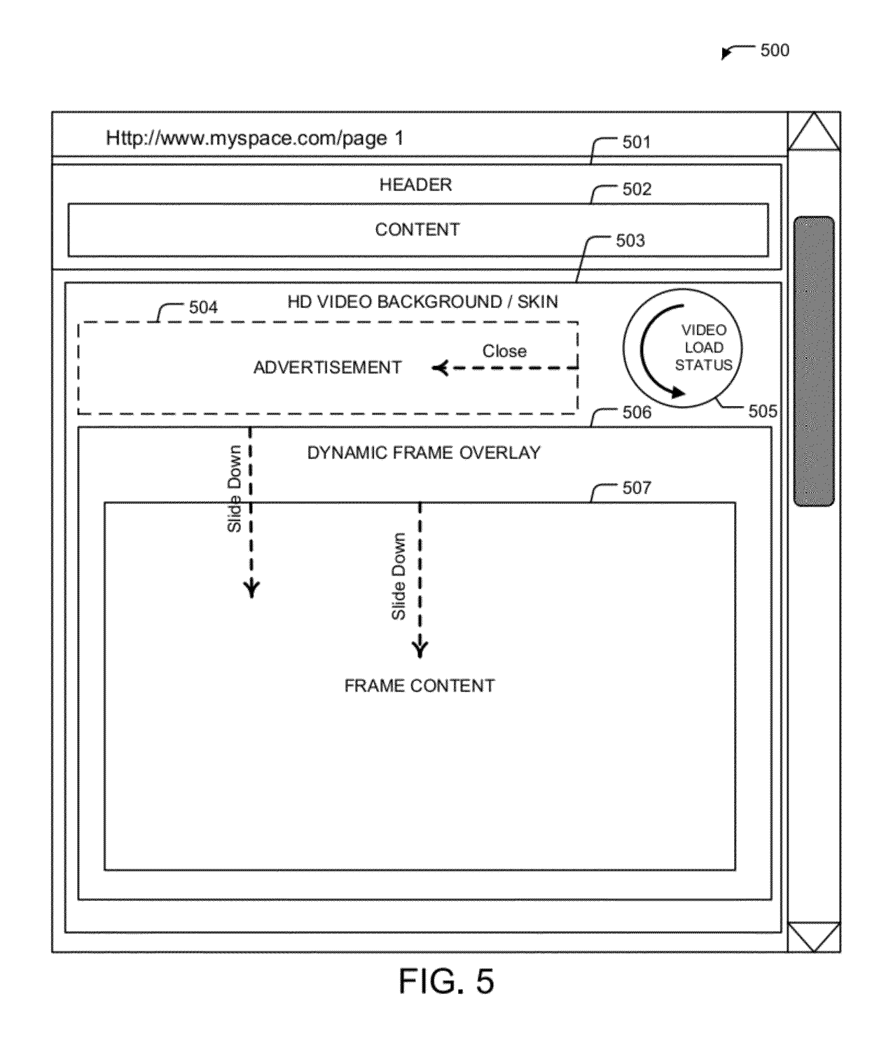

FIG. 4 illustrates a user interface or webpage diagram 400, according to an example embodiment. The webpage 400 may be somewhat similar to webpage 300. For example, the webpage 400 may include header 401, header content 402, video skin 403, dynamic frame overlay 406, and frame content 407. As illustrated, a user's cursor is positioned over an “action” portion 405 of exposed background skin 403, resulting in rendering of video content and dynamic modification of the webpage, as shown in FIGS. 5-7

FIG. 5 illustrates a user interface or webpage diagram 500, according to an example embodiment. The webpage 500 may be somewhat similar to webpages 300 and 400. For example, the webpage 500 may include header 501, header content 502, video skin 503, dynamic frame overlay 506, and frame content 507. As shown in FIG. 5, video content is being loaded (e.g., HD video content), the loading is being indicated with status indicator 505, and the webpage 500 is dynamically reconfiguring itself to expose more of the video skin 503 for the user.

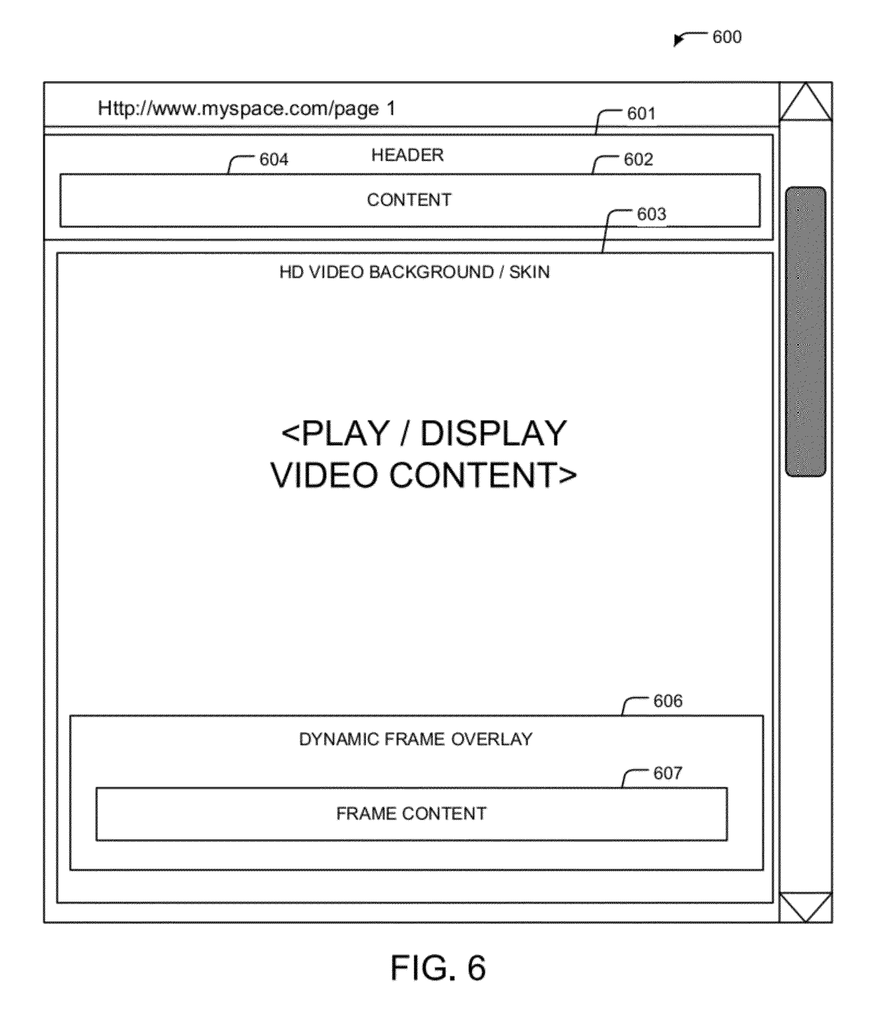

FIG. 6 illustrates a user interface or webpage diagram, according to an example embodiment. The webpage 600 may be considered a dynamically reconfigured version of webpages 300, 400, and 500. For example, webpage 600 may include header 601, header content 602, video skin 603, dynamic frame overlay 606, and frame content 607. As illustrated, the reconfigured webpage 600 includes a larger exposed portion of background skin 603 as compared to FIGS. 3-5. As also shown, video content is being displayed for a user on the video skin 603. Although video is explicitly stated and illustrated as being played on FIG. 6, it should be understood that video may also be constantly or intermittently played on any video skin described herein. For example, video skin 203, 303, 403, and 503 may intermittently or constantly play video depending upon any desired implementation.

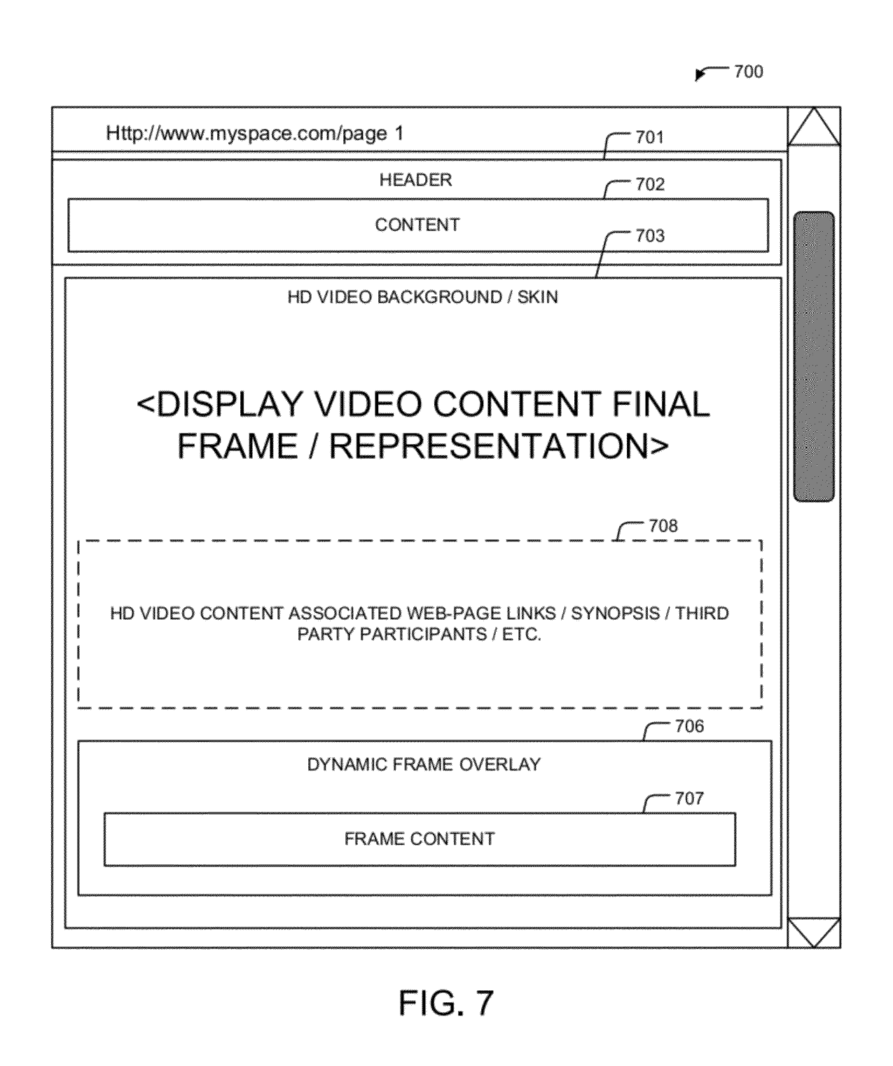

FIG. 7 illustrates a user interface or webpage diagram 700, according to an example embodiment. The webpage 700 may be a dynamically reconfigured version of webpages 300, 400, 500, and 600. For example, the webpage 700 may include header 701, header content 702, video skin 703, dynamic frame overlay 706, and frame content 707. As shown, video content playback on the webpage 700 may have ceased, paused, or may have been terminated by a user. Subsequent to cessation of playback, a final frame or an advertisement/graphic/image representing the video content previously presented on the video skin 703 is presented to a user along with webpage links, synopsis, third party information, or other information/dynamic content associated with the video content in an exposed area 708 of the video skin 703.

As described above, a user may be presented with a webpage including a video skin background with a plurality of content arranged thereon. The content may be dynamically changed such that HD video may be played directly on the background skin, and different content on the webpage may be repositioned/reconfigured dynamically based upon user interaction with the webpage. Furthermore, the content and HD Video/background skin may be compiled within a single file or relatively small number of files to better present a fluid user experience.

Hereinafter, methods of providing rich media to users through a website are described in detail.

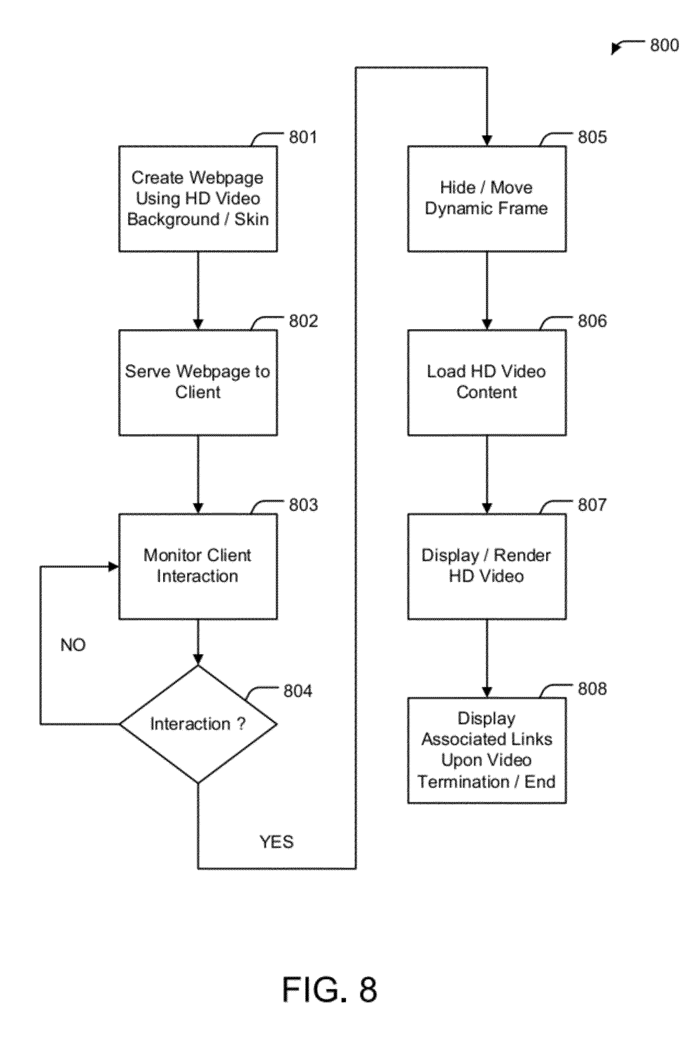

FIG. 8 illustrates a flowchart of a method, according to an example embodiment. As shown, the method 800 includes creating a webpage using a video background/skin at block 801. The video background may be targeted to a user, and may be provide by an Ad call server or third party server. The webpage may be created or aggregated within a single file or relatively small number of files, for example, within FLASH files or other suitable files. The webpage may be created at a third party server separate a website hosting server, or may be created within the website hosting server.

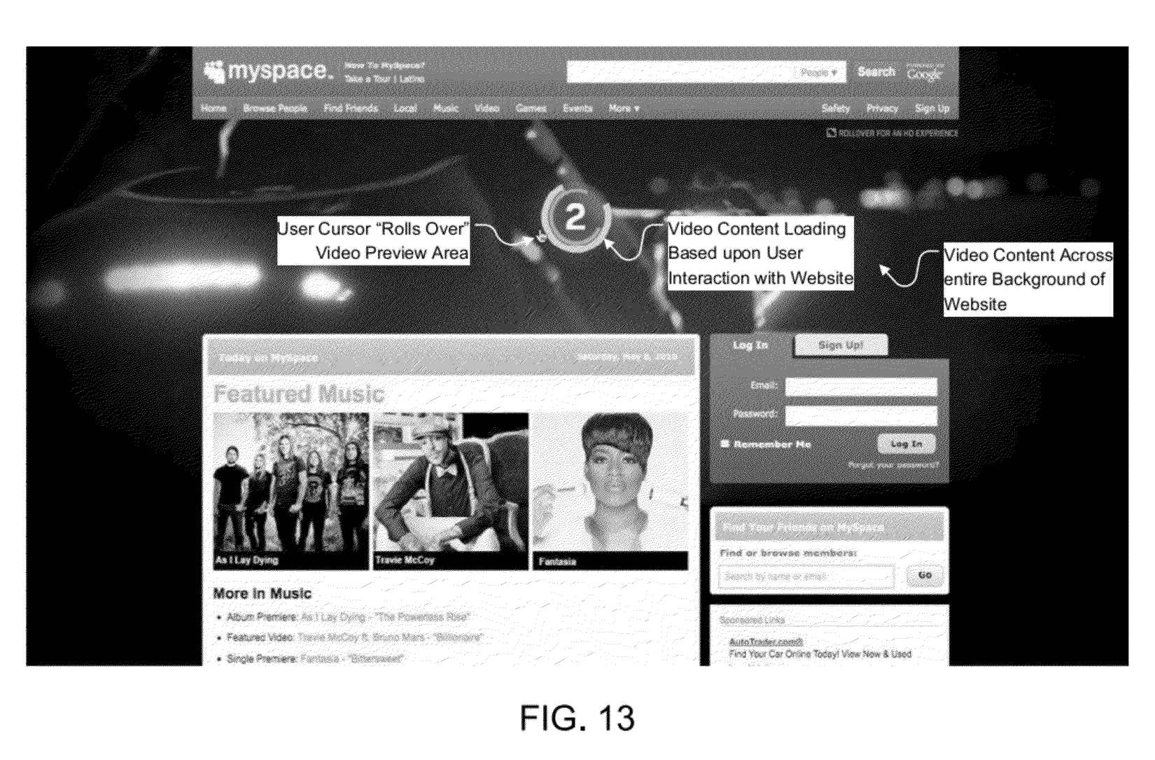

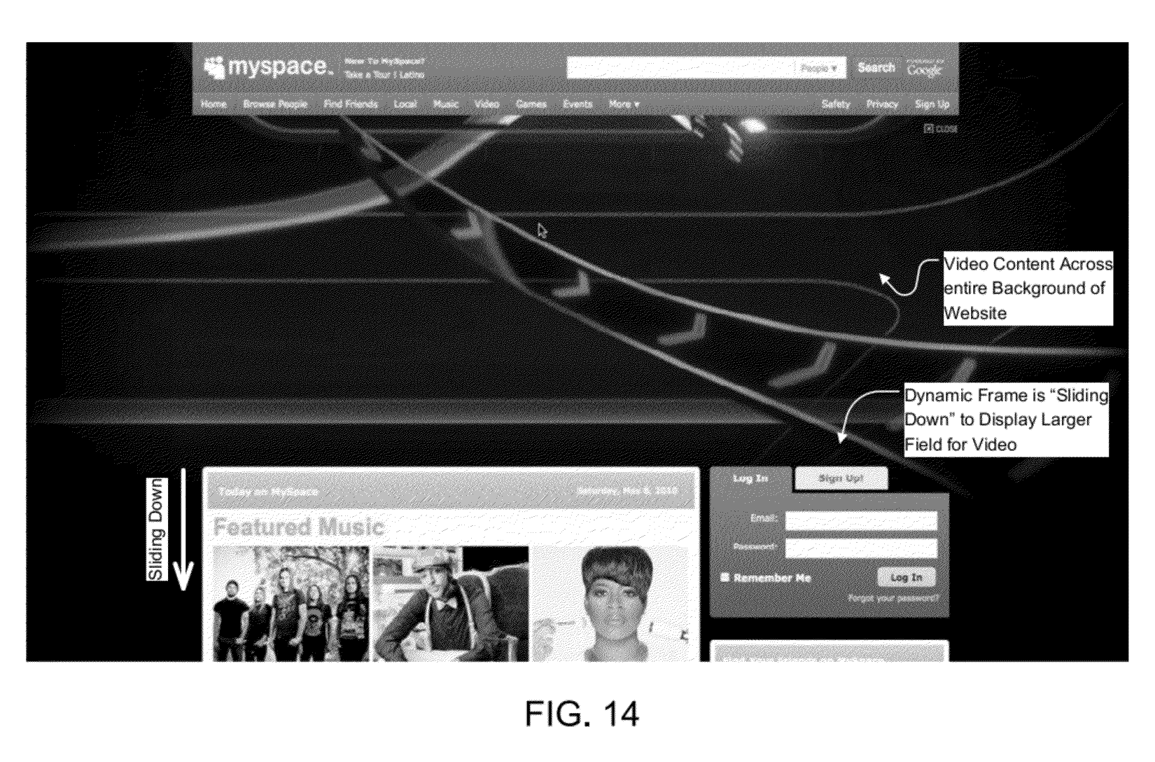

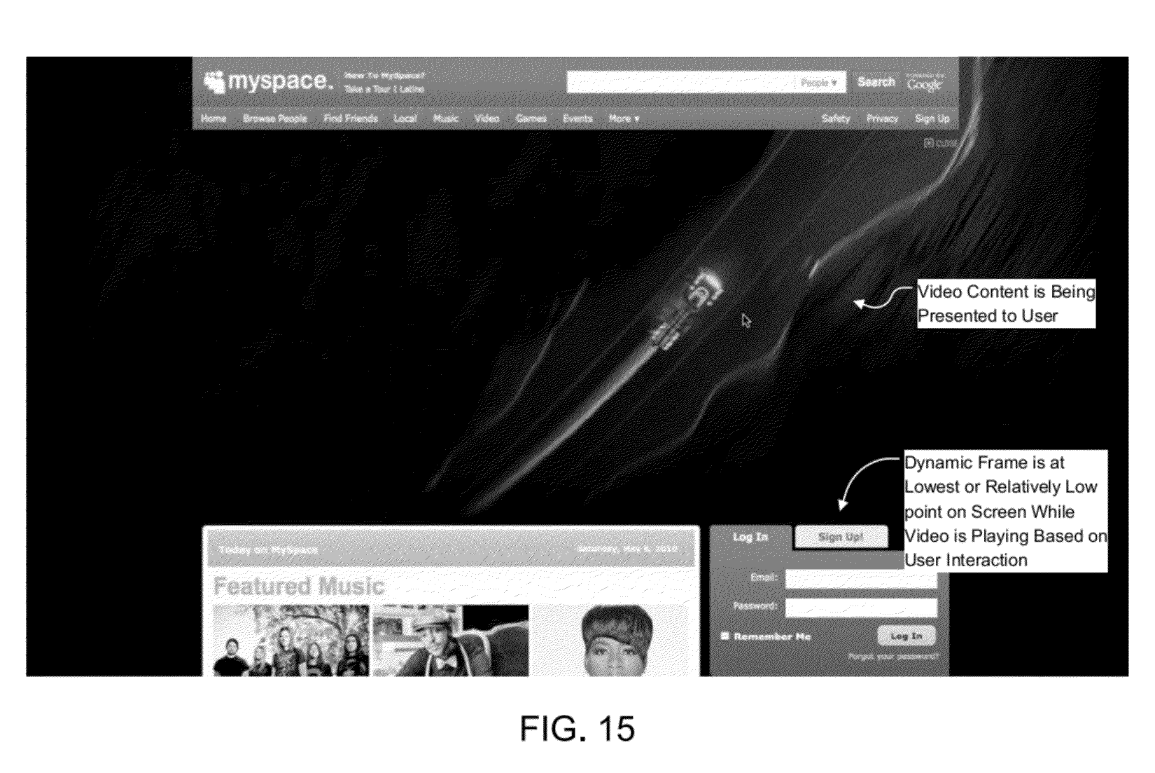

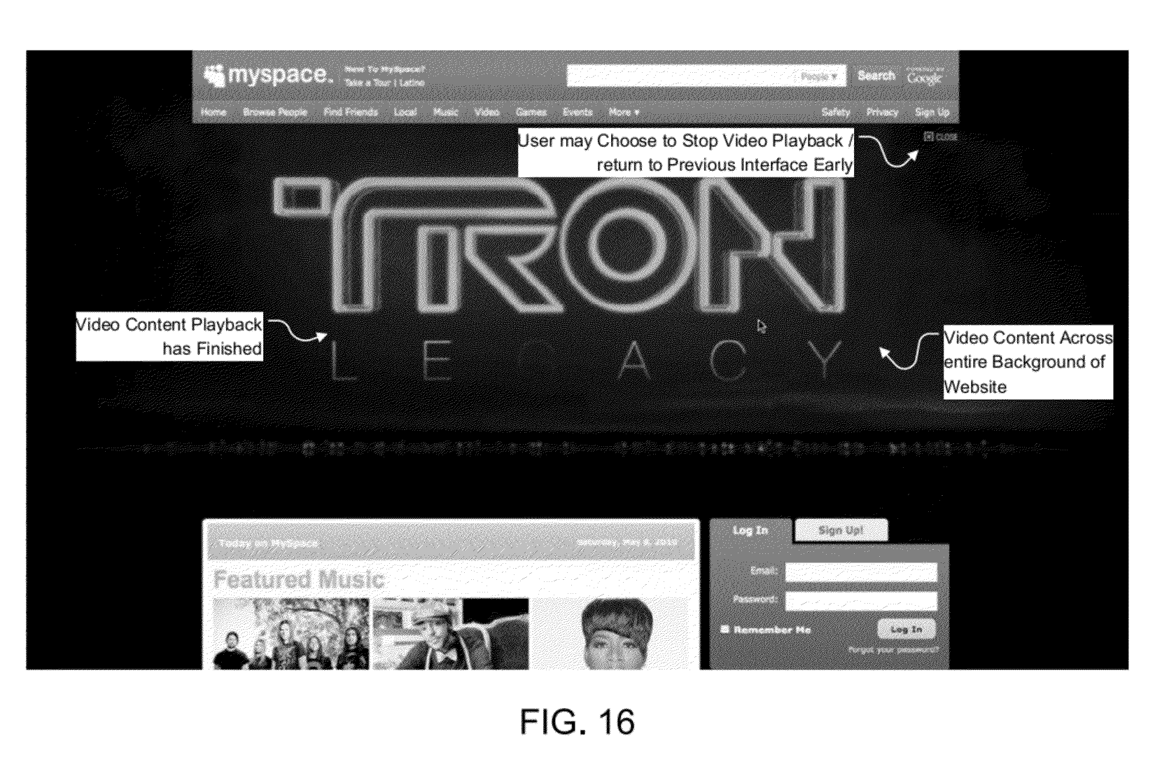

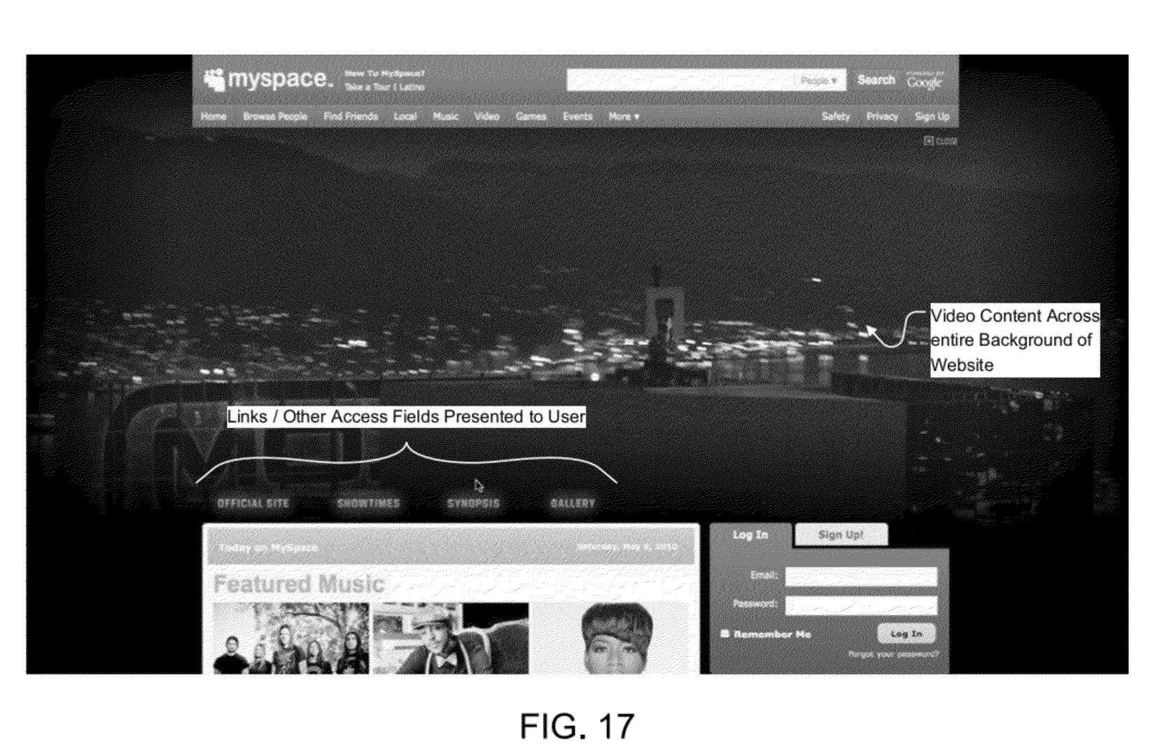

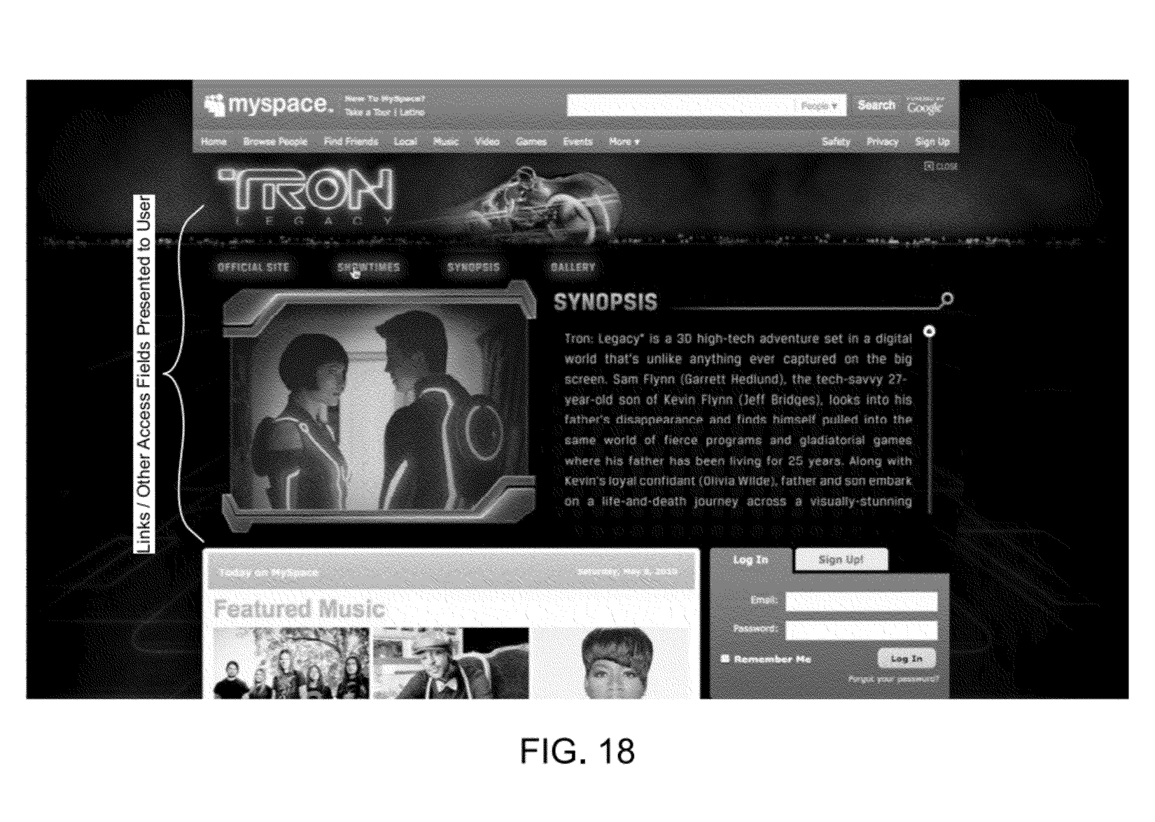

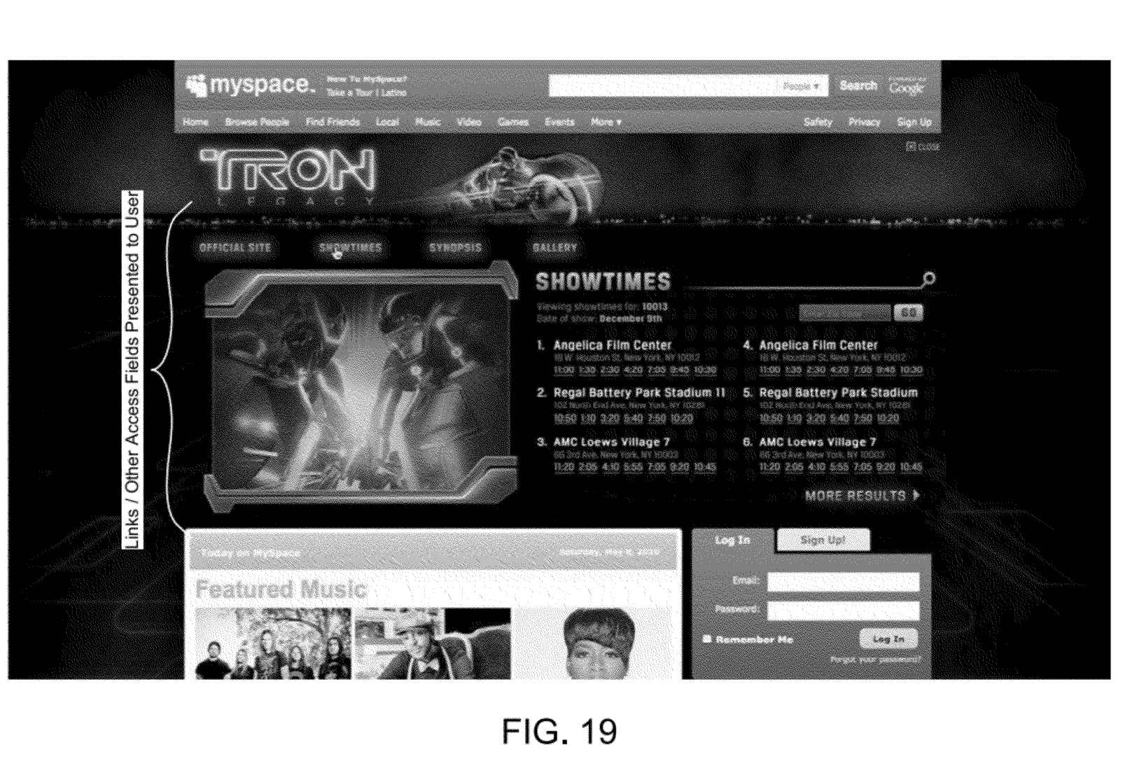

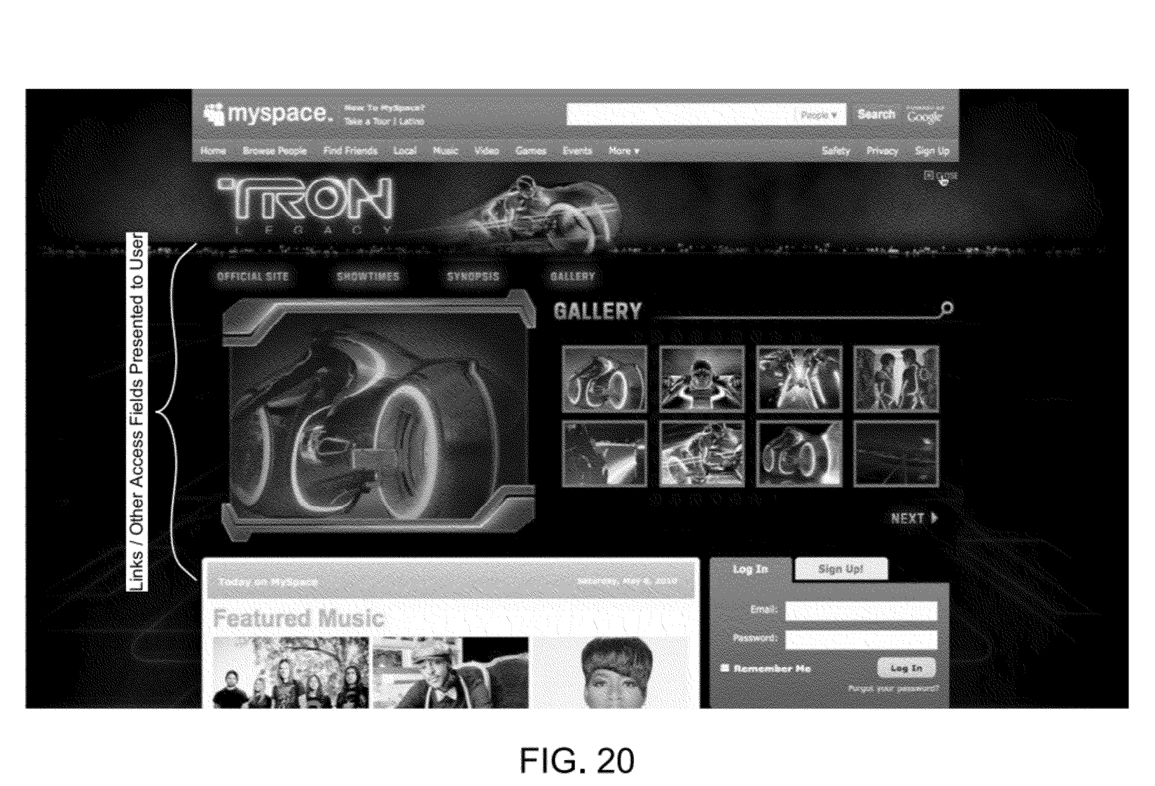

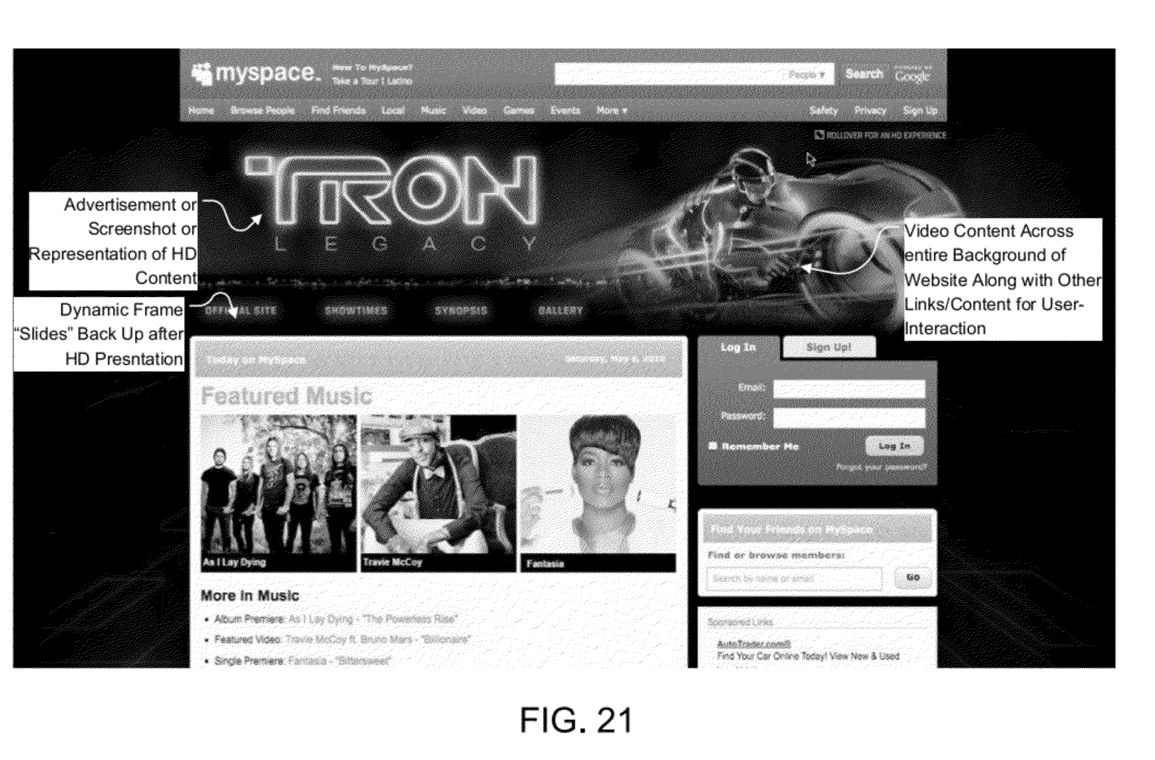

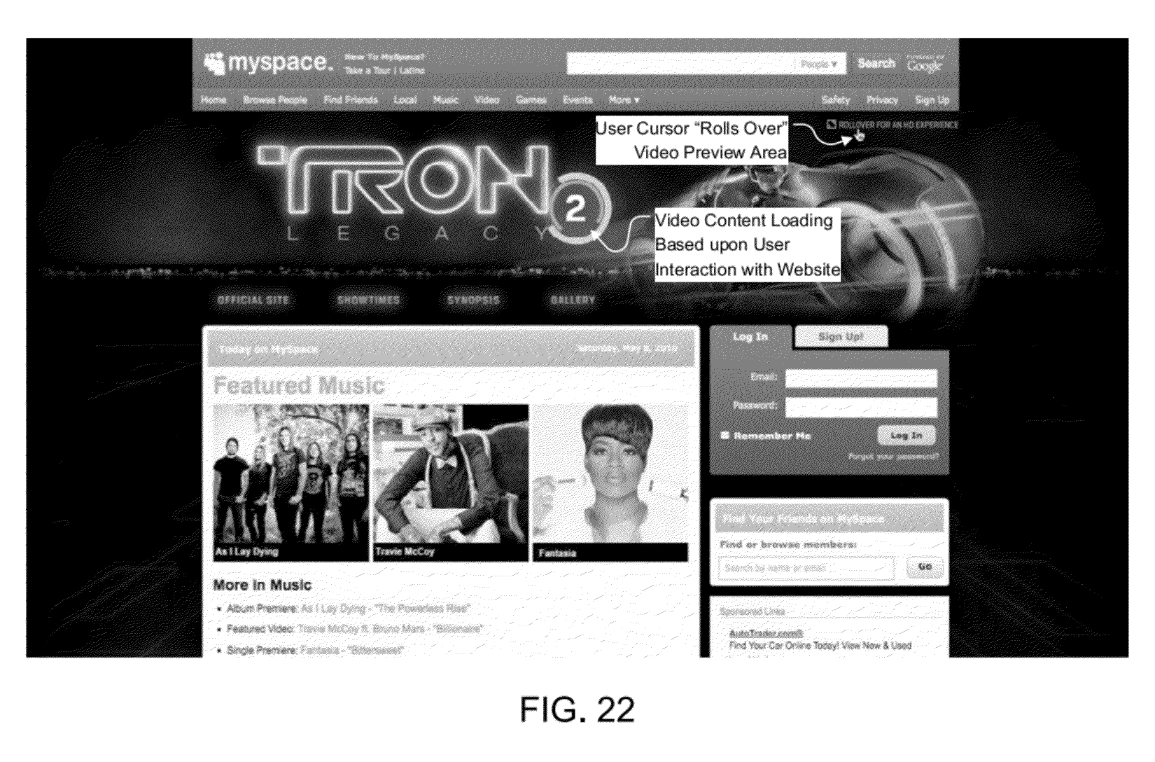

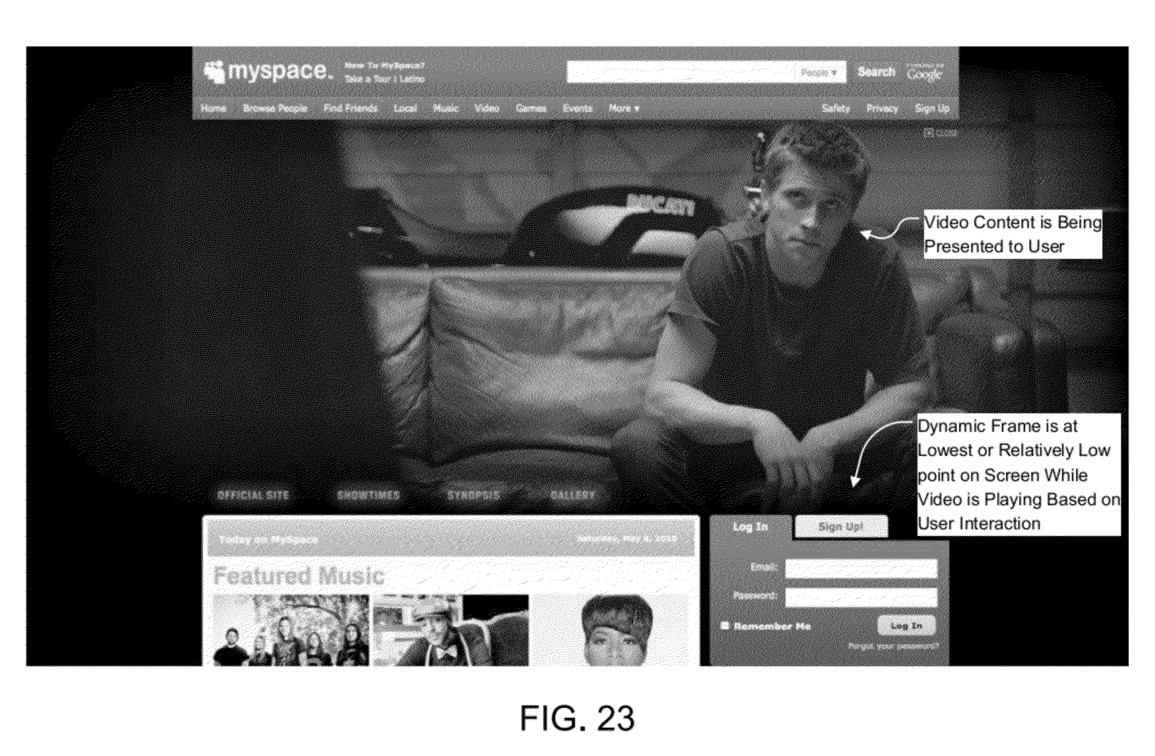

The method 800 further includes serving the webpage to a client at block 802. The webpage may be served over a network, through a third party server, or through a website hosting server. For example, according to at least one example embodiment, a user may access a website through a website hosting server. The website hosting server may contact an Ad server to retrieve or request retrieval of video content and other webpage content associated with the video. This content may be communicated to the website hosting server, or to a third party server, or any combination thereof. Upon receipt, the content is processed to create a webpage which includes the features of any, all, or any combination of FIGS. 1-7, and 12-23.

The method 800 further includes monitoring client interaction at blocks 803-804. If a user or client interacts with a portion of a background skin, this interaction may be interpreted as a user wishing to be presented with fluid video content which retaining some accessibility to the webpage. Thus, the method 800 may include hiding or moving, or reconfiguring the webpage by repositioning or sliding dynamic frames and/or other content at block 805. The video content is loaded, displayed/rendered, and presented to the user (806-807). After video playback has ceased, or if a user terminates playback early, or if a user interacts with another portion of the webpage, the method may include displaying associated links or other content associated with the video content at block 808, or may simply return the webpage to a form initially presented to the user at block 802.

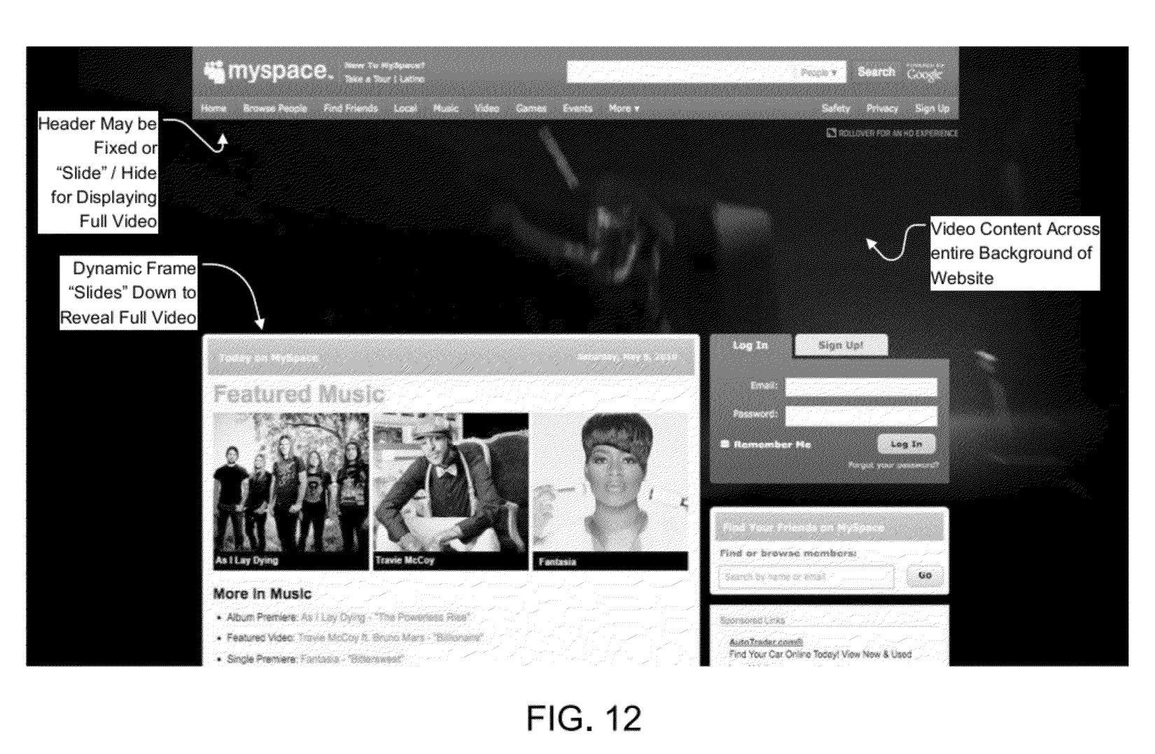

Additional detail and insight into the methods described above and the webpage diagrams presented in FIGS. 1-7 are presented in FIGS. 12-23.

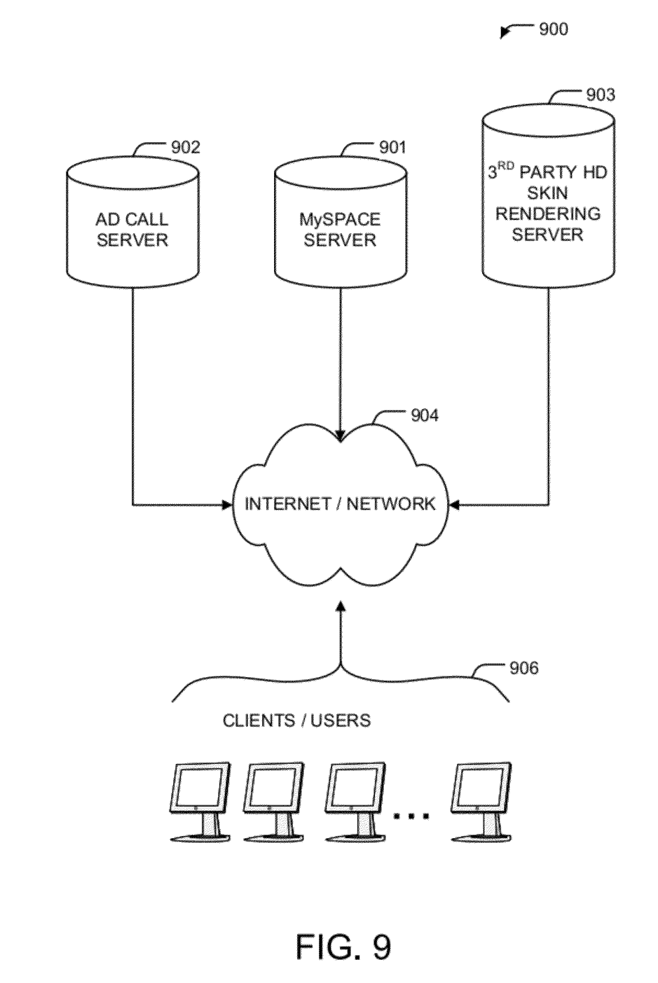

FIGS. 12-23 illustrate a webpage interface operating according to the method of FIG. 8, and provided/served through a system at least somewhat similar to the system/network depicted in FIG. 9.

As illustrated in FIG. 9, a website/service provider 901 may provide a website hosting service over network 904. The network 904, and therefore the website, may be accessed by a plurality of users 906. Further, a third party server 903 may be in communication with the service provider and/or network, and may therefore be in communication with the plurality of users 906. Furthermore, an Advertising (Ad) call server 902 may also be in communication with the network 904, and may therefore be in communication with any of the servers 901, 903, and the plurality of users 906.

The Ad call server 902 may be a server configured to decide upon particular content to present to any of the plurality of users 906. In response to any determination and/or decision, the Ad call server may communicate said content to the 3^{rd} party server 903. The 3^{rd} party server is configured to create a webpage to display/serve to the user using the received content.

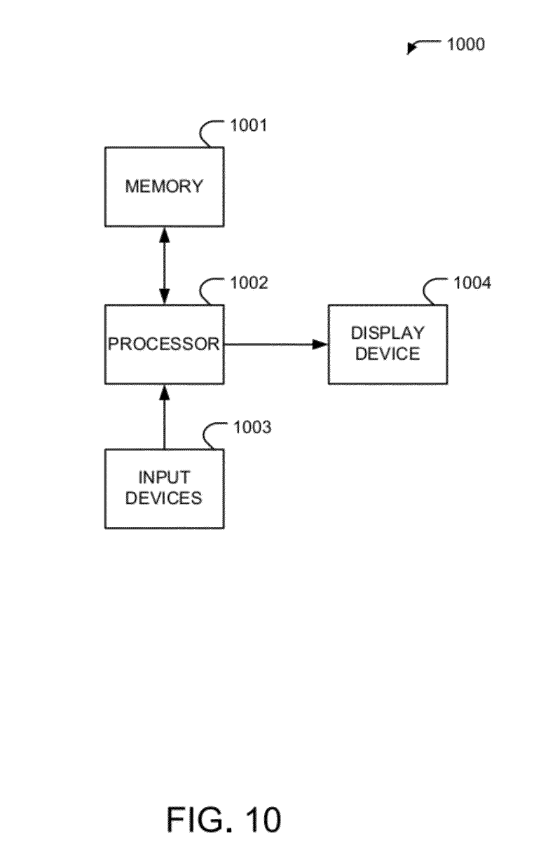

It is further noted that embodiments of the invention may be embodied in the form of computer-implemented processes and apparatuses for practicing those processes. Therefore, according to an exemplary embodiment, the methodologies described hereinbefore may be implemented by a computer system or apparatus. For example, FIG. 10 illustrates a computer apparatus, according to an exemplary embodiment. Therefore, portions or the entirety of the methodologies described herein may be executed as instructions in a processor 1002 of the computer system 1000. The computer system 1000 includes memory 1001 for storage of instructions and information, input device(s) 1003 for computer communication, and display device 1004. Thus, the present invention may be implemented, in software, for example, as any suitable computer program on a computer system somewhat similar to computer system 1000. For example, a program in accordance with the present invention may be a computer program product causing a computer to execute the example methods described herein.

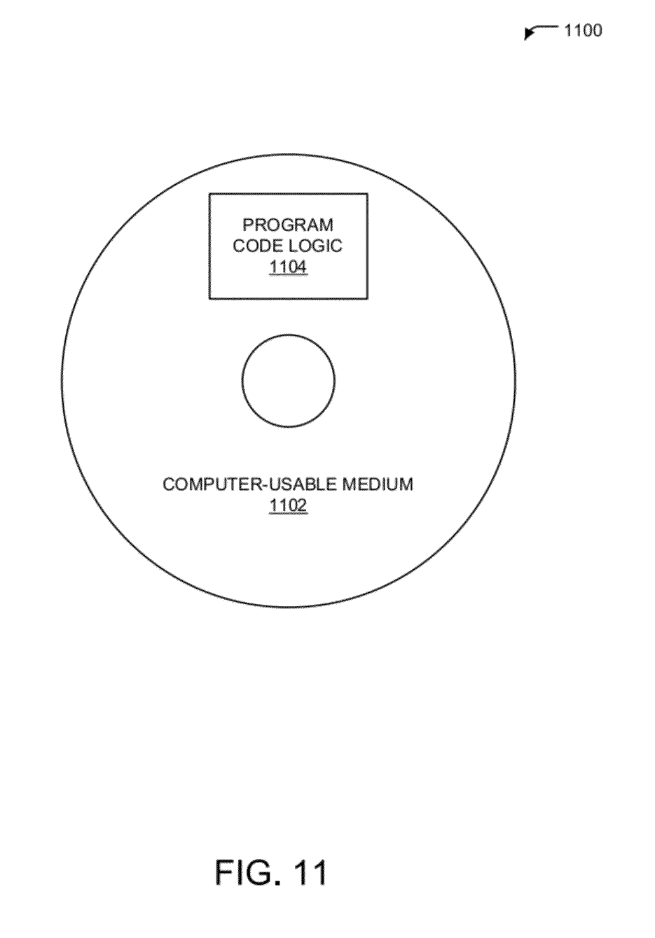

Therefore, embodiments can be embodied in the form of computer-implemented processes and apparatuses for practicing those processes on a computer program product. Embodiments include the computer program product 1100 as depicted in FIG. 11 on a computer usable medium 1102 with computer program code logic 1104 containing instructions embodied in tangible media as an article of manufacture. Exemplary articles of manufacture for computer usable medium 1102 may include floppy diskettes, CD-ROMs, hard drives, universal serial bus (USB) flash drives, or any other computer-readable storage medium, wherein, when the computer program code logic 1104 is loaded into and executed by a computer, the computer becomes an apparatus for practicing the invention. Embodiments include computer program code logic 1104, for example, whether stored in a storage medium, loaded into and/or executed by a computer, or transmitted over some transmission medium, such as over electrical wiring or cabling, through fiber optics, or via electromagnetic radiation, wherein, when the computer program code logic 1104 is loaded into and executed by a computer, the computer becomes an apparatus for practicing the invention. When implemented on a general-purpose microprocessor, the computer program code logic 1104 segments configure the microprocessor to create specific logic circuits.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should be emphasized that the above-described example embodiments of the present invention, including the best mode, and any detailed discussion of particular examples, are merely possible examples of implementations of example embodiments, and are set forth for a clear understanding of the principles of the invention. Many variations and modifications may be made to the above-described embodiment(s) of the invention without departing from the spirit and scope of the invention. All such modifications and variations are intended to be included herein within the scope of this disclosure and the present invention and protected by the following claims.

What is claimed is:

1. A webpage for providing rich media content to users, comprising:
a file, the file including computer executable instructions that when executed on a host processor of a computer apparatus, direct the apparatus to render the webpage, the file comprising:
a high-definition video background rendering portion; and
a content overlay rendering portion.

2. The webpage of claim 1, wherein the file further comprises a dynamic frame overlay rendering portion.

3. The webpage of claim 2, wherein the dynamic frame overlay rendering portion includes computer executable instructions that when executed at the host processor of the computer apparatus, direct the computer apparatus to dynamically rearrange a frame overlaying a high-definition video background such that an increasing or decreasing amount of video contained in the background is presented to a user.

4. A method of providing rich media content to users, comprising:
creating a webpage, the webpage including a high-definition video background and overlaying content;
serving the webpage to a client;
monitoring client interaction with the served webpage;
rearranging the webpage overlaying content in response to monitored user interaction, the rearranging including increasing or decreasing an amount of video presented to a user as viewed through exposed portions of the high-definition video background, the increasing and decreasing facilitated through increasing or decreasing the sizes exposed portions of the high-definition video background.

5. A system of providing rich media content to users, comprising:
a website server; and
a third party webpage rendering server in communication with the website server, the third party webpage rendering server is configured to perform a method, comprising:
creating a webpage, the webpage including a high-definition video background and overlaying content;
serving the webpage to a client;
monitoring client interaction with the served webpage;
rearranging the webpage overlaying content in response to monitored user interaction, the rearranging including increasing or decreasing an amount of video presented to a user as viewed through exposed portions of the high-definition video background, the increasing and decreasing facilitated through increasing or decreasing the sizes exposed portions of the high-definition video background.

6. A system of providing rich media content to users, comprising:
an advertising server;
a website server in communication with the advertising server; and
a third party webpage rendering server in communication with the advertising server and the website server, the third party webpage rendering server is configured to perform a method, comprising:
receiving high-definition video background content from the advertising server;
receiving overlaying content from the website server;
creating a webpage, the webpage including the high-definition video background and overlaying content;
serving the webpage to a client;
monitoring client interaction with the served webpage;
rearranging the webpage overlaying content in response to monitored user interaction, the rearranging including increasing or decreasing an amount of video presented to a user as viewed through exposed portions of the high-definition video background, the increasing and decreasing facilitated through increasing or decreasing the sizes exposed portions of the high-definition video background.

7. A system of providing rich media content to users, comprising:
a plurality of clients; and
a webpage rendering server in communication with the plurality of clients, the webpage rendering server configured to create and store a file, the file including computer executable instructions that when executed on a host processor of a computer apparatus, direct the apparatus to render a webpage, the file comprising:
a high-definition video background rendering portion; and
a content overlay rendering portion.

8. The system of claim 7, wherein the webpage rendering server is further configured to serve the file to at least one of the plurality of clients, and the at least one of the plurality of clients is configured to access the file and execute the high-definition video background rendering portion and the content overlay rendering portion.

9. The system of claim 8, wherein the at least one of the plurality of clients is further configured to transmit information related to user interaction with the executing high-definition video background rendering portion.
